(19) United States
(12) Patent Application Publication
(10) Pub. No.: US 2025/0297173 A1
(43) Pub. Date: Sep. 25, 2025

(54) METHOD FOR MAKING HYDRODEOXYGENATION AND HYDROTREATING SLURRY CATALYSTS AND THEIR APPLICATION TO RENEWABLE FUEL PRODUCTION

(71) Applicant: CHEVRON U.S.A. INC., San Ramon, CA (US)

(72) Inventors: Shuwu YANG, Richmond, CA (US); Bo KOU, Albany, CA (US); Goutam BISWAS, Danville, CA (US); Michelle K. YOUNG, Manvel, TX (US); Theodorus Ludovicus Michael MAESEN, Spring, TX (US)

(21) Appl. No.: 19/085,838

(22) Filed: Mar. 20, 2025

Related U.S. Application Data
(60) Provisional application No. 63/568,377, filed on Mar. 21, 2024.

(51) Int. Cl. C10G 49/12; B01J 35/27; B01J 35/40; B01J 35/61; B01J 35/63; B01J 37/00; C10C 3/02

(52) U.S. Cl. CPC C10G 49/12; B01J 35/27; B01J 35/40; B01J 35/613; B01J 35/615; B01J 35/617; B01J 35/618; B01J 35/633; B01J 35/635; B01J 37/0072; C10C 3/023; C10G 2300/1014; C10G 2300/1018

(57) ABSTRACT

A method is disclosed for making a slurry catalyst concentrate. The method includes reducing an average particle size of a first hydrotreating catalyst component to produce a reduced hydrotreating catalyst component having a reduced average particle size, wherein first hydrotreating catalyst component comprises one or more active metal components selected from Group VIB, Group VIII, and Group II metals; and mixing the reduced hydrotreating catalyst with a renewable liquid carrier composition in a mixing vessel to provide a slurry catalyst concentrate comprising 1 to 60 wt. % of the reduced hydrotreating catalyst component in the renewable liquid carrier composition.

### CROSS-REFERENCE TO RELATED APPLICATIONS

This application claims priority to and the benefit of U.S. Provisional Application No. 63/568,377 having a filing date of Mar. 21, 2024, the disclosure of which is incorporated herein by reference in its entirety.

### FIELD

The present disclosure relates to a method for making a catalyst and a process for slurry hydroprocessing of renewable feedstocks in the presence of the catalyst to provide usable products and further prepare feedstocks for further refining.

### BACKGROUND

As the demand for transportation fuels increases worldwide, there is increasing interest in feedstock sources other than petroleum crude oil. Currently renewable fuels are mainly produced from lipids and biomass-derived feedstocks. The oxygen content in these feedstocks is high and needs to be removed first via hydrodeoxygenation (HDO) before further hydroprocessing to generate drop-in renewable fuels. An efficient and easy-to-make catalyst system is needed to achieve HDO conversion targeting a slurry reactor platform.

### SUMMARY

In a first aspect, there is provided a method of making a slurry catalyst concentrate comprising: (a) reducing an average particle size of a first hydrotreating catalyst component to produce a reduced hydrotreating catalyst component having a reduced average particle size, wherein first hydrotreating catalyst component comprises one or more active metal components selected from Group VIB, Group VIII and Group IIB metals; and (b) mixing the reduced hydrotreating catalyst component with a renewable liquid carrier composition in a mixing vessel to provide a slurry catalyst concentrate comprising 1 to 60 wt. % of the reduced hydrotreating catalyst in the liquid renewable carrier composition.

In a second aspect, there is provided a process for slurry hydroprocessing, comprising: (a) reducing an average particle size of a first hydrotreating catalyst component to produce a reduced hydrotreating catalyst component having a reduced average particle size, wherein the first hydrotreating catalyst comprises one or more active metal components selected from Group VIB, Group VIII and Group IIB metals; (b) mixing the reduced hydrotreating catalyst component with a renewable liquid carrier composition in a mixing vessel to provide a slurry catalyst concentrate comprising 1 to 60 wt. % of the reduced hydrotreating catalyst in the liquid renewable carrier composition; and (c) charging the slurry catalyst concentrate and a biomass feedstock to a slurry hydroprocessing reactor.

### DETAILED DESCRIPTION

### Definitions

The term “hydroprocessing” refers to any process that is carried out in the presence of hydrogen and a catalyst. Such processes include, but are not limited to, hydrogenation, hydrodeoxygenation, hydrodesulfurization, hydrodenitrogenation, hydrodemetallization, hydrodearomatization, hydroisomerization, hydrodewaxing, and hydrocracking.

The term “hydrotreating catalyst” encompasses catalysts having activity for any of hydrodeoxygenation (HDO) of organic oxygen-containing molecules to form water, decarbonylation or decarboxylation of organic oxygen-containing molecules to form CO and CO₂, respectively; hydrodenitrification (HDN) of organic nitrogen-containing molecules; and/or hydrodesulfurization (HDS) of organic sulfur-containing molecules. Since the main heteroatom removed during hydrotreatment of biological feedstocks is oxygen, the term “hydrodeoxygenation” may be used interchangeably with hydrotreating in this disclosure.

The term “slurry catalyst” refers to a composition comprising solid catalyst particles and a carrier liquid (e.g., a liquid diluent).

The term “renewable” means a material from a renewable source. A renewable source may be animal, vegetable, microbial, and/or bio-derived or mineral-derived waste materials suitable for the production of fuels, fuel components and/or chemical feedstocks.

### Method of Making a Slurry Catalyst Concentrate

A method of making a slurry catalyst concentrate is provided. The method comprises (a) reducing an average particle size of a first hydrotreating catalyst component to produce a reduced hydrotreating catalyst component having a reduced average particle size, wherein the first hydrotreating catalyst component comprises one or more active metal components selected from Group VIB, Group VIII and Group IIB metals; and (b) mixing the reduced hydrotreating catalyst component with a renewable liquid carrier composition to provide a slurry catalyst precursor concentrate.

In step (a), various methods of reducing particle size can be employed, and typically, such methods can comprise at least one of impact, shear, compression, vibration (e.g., ultrasonic vibration), grinding, and crushing, as well as combinations of two or more of these size reduction mechanisms. The particle size can be reduced using any suitable comminution device, including but not limited to, an impact crusher, a hammer mill, a jet mill, a roll mill, a roll crusher, a jaw crusher, an ultrasonic device, and the like, or any combination thereof. Typically, the input to the comminution device can be referred to as a first hydrotreating catalyst, and the output from the comminution device can be referred to as a reduced hydrotreating catalyst system component. As used herein, the “first” catalyst component is meant to indicate a larger size (e.g., coarse), while the “reduced” catalyst component is meant to indicate a smaller size (e.g., fine), i.e., the average particle size of the first hydrotreating catalyst component is greater than the average particle size of the reduced hydrotreating catalyst. In some embodiments, the first hydrotreating catalyst can be the grade of that component that is commercially available, and often, at an average particle size that is larger than desired for a slurry reactor system.

The average particle size (d50) may be measured by laser light scattering techniques, with dispersions or dry powders, for example according to ASTM D4464. Particle size refers to primary particles.

Any disclosure of an average particle size is meant to encompass the average particle size on a number basis as well the average particle size on a volume basis (e.g., the average particle size in the volume basis generally can be dominated by larger particles and can be less sensitive to fines). Thus, by stating that the average particle size of the first hydrotreating catalyst component can be reduced to form the reduced hydrotreating catalyst component, this encompasses both the average particle size (on a number basis) of the first hydrotreating catalyst component can be reduced to form the reduced hydrotreating catalyst component, and the average particle size (on a volume basis) of the first hydrotreating catalyst component can be reduced to form the reduced hydrotreating catalyst component. In situations where the average particle sizes of the first hydrotreating catalyst component and the reduced hydrotreating catalyst component are compared, the average particle sizes should be compared on the same basis (i.e., either on a number basis or on a volume basis).

The first hydrotreating catalyst component that may require a reduction in particle size often can have an average particle size, prior to reducing step (a), of 750 μm or greater, 1000 μm or greater, 1250 μm or greater, or 1500 μm or greater (on a number basis and/or on a volume basis). Suitable ranges for the average particle size of the first catalyst system component, prior to reducing step (a), can include the following ranges: from 750 to 5000 μm; alternatively, from 1000 to 5000 μm; alternatively, from 500 alternatively, from 750 to 3000 μm; or alternatively, from 1000 to 3000 μm.

The average particle size of the reduced hydrotreating catalyst component, after reducing step (a), generally can be 500 μm or lower, for example, 250 μm or lower, 100 μm or lower, or 50 μm or lower (on a number basis and/or on a volume basis). Suitable ranges for the average particle size of the reduced catalyst system component, after reducing step (a), can include, but are not limited to, the following ranges: from 1 to 500 μm; alternatively, from 1 to 250 μm; alternatively, from 1 to 100 μm; alternatively, from 1 to 50 μm; alternatively, from 5 to 500 μm; alternatively, from 5 to 250 μm; from 5 to 100 μm; or alternatively, from 5 to 50 μm.

In step (b), the slurry is formed by providing the reduced hydrotreating catalyst component and renewable liquid carrier to a mixing device. The mixing device is any device suitable for forming a slurry, and may be, for example, a slurry mix tank. More generally, the mixing device may be a vessel, preferably a vertical vessel, that contains an agitator with one or more impellers and one or more baffles protruding from an inside wall of the vessel. The device preferably further includes a recirculating fluid conduit capable of recirculating the slurry out of and into the mixing vessel (e.g., by use of a fluid pump). The device is intended to thoroughly mix the solids in the liquid vertically and axially, and further to prevent the solids from settling to the bottom of the vessel.

Mixing of the reduced hydrotreating catalyst component and the renewable liquid carrier composition to produce the slurry concentrate may occur for any suitable amount of time (e.g., seconds to minutes to hours or longer) and at any suitable rate to produce the slurry where the reduced hydrotreating catalyst component is substantially homogeneously dispersed in the fluid. For example, mixing may occur for 5 minutes to 3 hours (e.g., 10 minutes to 3 hours, or 30 minutes to 3 hours) at a vigorous rate. High shear mixing is an example of a suitable method for mixing the reduced hydrotreating catalyst and the renewable liquid carrier composition.

In aspects, the mixing vessel can be configured to maintain the catalyst slurry at a temperature in a range of 20° C. to 200° C.; alternatively, in a range of about 50° C. to 150° C.); alternatively, in a range of 10° C. to 100° C.; alternatively, within about 20° C. (or 10° C.) of a boiling point of the renewable liquid carrier composition.

In aspects, the mixing vessel can be configured to maintain the catalyst slurry at a pressure in a range of about 0 kPa to 2000 kPa; alternatively, in a range of about 0 kPa to 1000 kPa; alternatively, in a range of about 100 kPa to 1000 kPa.

If the concentration of the reduced hydrotreating catalyst component in the slurry is too high, it may be difficult to transport the slurry (e.g., by pumping), such that the slurry is no longer readily transported, and/or such that it potentially plugs. On the other hand, it would be just as undesirable to obtain a slurry with too little reduced hydrotreating catalyst component in the renewable liquid carrier composition.

Accordingly, in preferred embodiments, the slurry composition comprises 1 to 60 wt. %, such as 3 to 45 wt. % or 5 to 30 wt. %, preferably 10 to 30 wt. %, more preferably 10 to 20 wt. %, reduced hydrotreating catalyst component in the renewable liquid carrier composition, with ranges from any of the foregoing low ends to any of the foregoing high ends also contemplated in various embodiments. In some embodiments, the balance of the slurry is preferably the renewable liquid carrier composition. Thus, in various embodiments, the slurry may be characterized as comprising renewable liquid carrier within the range from 40 to 99 wt. %, such as 55 to 97 wt. % or 65 to 95 wt. % or 70 to 95 wt. %, preferably 70 to 90 wt. %, more preferably 80 to 90 wt. %, with ranges from any of the foregoing low ends to any of the foregoing high ends also contemplated in various embodiments.

Once the slurry concentrate is produced, the method may further include heating the concentrate. Heating may be to a temperature of from 50° C. to 200° C. (e.g., 75° C. to 150° C.). Further, heating may be to a temperature that is within about 20° C. (or 10° C.) of a boiling point of the renewable liquid carrier composition.

Mixing to produce the slurry concentrate before heating may occur for any suitable amount of time (e.g., seconds to minutes to hours or longer) and at any suitable rate to produce the slurry concentrate where reduced hydrotreating catalyst is homogeneously dispersed in the renewable liquid oil carrier composition. For example, mixing may occur for 5 minutes to 3 hours (e.g., 10 minutes to 3 hours, or 30 minutes to 3 hours) at a vigorous rate before heating.

Preferably, the method includes mixing the slurry concentrate while heating the slurry concentrate so that the reduced hydrotreating catalyst component does not settle. Heating the slurry may occur for any suitable amount of time (e.g., seconds to minutes to hours or longer) and at any suitable mixing rate to maintain a dispersion. For example, heating may occur for 5 to 3 hours (e.g., 10 minutes to 3 hours) at a vigorous rate while the slurry is at an elevated temperature.

### Hydrotreating Catalyst

The hydrotreating catalyst in size reducing step (a) may be any catalyst known in the art that is suitable for hydrotreating. The hydrotreating catalyst typically contains one or more active metal components of metals or metal compounds selected from Group VIB, Group VIII and Group IIB of the Periodic Table of the Elements. Preferably, the Group VIB metal element is at least one selected from the group consisting of chromium (Cr), molybdenum (Mo) and tungsten (W), the Group VIII metal is at least one selected from the group consisting of iron (Fe), cobalt (Co) and nickel (Ni), and the Group IIB metal is at least one selected from zinc (Zn). According to one embodiment, the active metal is at least one selected from Cr, Mo W, Fe, Co, Ni, and Zn, preferably at least one selected from Mo, W, Fe, Ni, Co, and Zn, more preferably selected from Mo, W, Fe, Co, Ni, CoMo, NiMo, NiW, and FeZn.

The hydrotreating catalyst can be present in either supported (i.e., the active metal component(s) is deposited or otherwise incorporated on a support material) or unsupported form (i.e., free of a support material). The support material is a support material which is inert or substantially inert under the reaction conditions and is preferably selected from the group consisting of carbon, activated carbon, silicon oxide, aluminum oxide, manganese oxide, cerium oxide, zirconium oxide, lanthanum oxide, titanium oxide, and mixtures of two or more of these materials. By “activated carbon” is herein understood an amorphous form of carbon with a surface area of at least 800 m²/g. Such activated carbon suitably has a porous structure. The hydrotreating catalyst is preferably present in supported form or as unsupported metal catalyst.

Total metal loadings on a supported hydrotreating catalyst are preferably in the range of from 1.5 wt. % to 50 wt. % expressed as a weight percentage of calcined hydrotreating catalyst in oxidic form (e.g., weight percentage of Ni, as Nio, and Mo, as MoO₃, on calcined oxidized NiMo on alumina support).

The hydrotreating catalyst may be a fresh hydrotreating catalyst, a spent hydrotreating catalyst, or a combination thereof. Spent catalyst may be used as a low-cost scavenger for “dirty” feeds. The term “fresh” when used in connection with the hydrotreating catalyst herein means the catalyst has not been used in a catalytic reaction after being manufactured. A “spent” catalyst is used herein generally to describe a used catalyst that has unacceptable performance in one or more of catalyst activity, hydrocarbon feed conversion, yield to a desired product(s), selectivity to a desired product(s), or an operating parameter, such as maximum operating temperature or pressure drop across a reactor, although the determination that a catalyst is “spent” is not limited only to these features. The unacceptable performance of the spent catalyst can be due to a carbonaceous build-up on the catalyst over time but is not limited thereto. A “deactivated” or “poisoned” catalyst has substantially no catalytic activity. A spent catalyst can be contacted with a catalyst poisoning agent, which effectively kills the activity of the resultant deactivated or poisoned catalyst. In some aspects, the “fresh” catalyst can have an activity X, the “spent” catalyst can have an activity Y, and the “deactivated” catalyst or “poisoned” catalyst can have an activity Z, such that Z<YXX. Thus, the activity of the spent catalyst is less than that of the fresh catalyst, but greater than that of the deactivated/poisoned catalyst (which can have no measurable catalyst activity). Catalyst activity comparisons (e.g., yield, selectivity) are meant to use the same production run (batch) of catalyst, tested on the same equipment, and under the same test method and conditions.

The hydrotreating catalyst may include a minor amount (i.e., up to 20 wt. %, up to 10 wt. %, or up to 5 wt. %) of floor sweep or catalyst fines (e.g., d50<250 μm) from a catalyst manufacturing plant.

In some examples, the hydrotreating catalyst exhibits a macropore volume of at least 0.10 cm³/g, preferably of at least 0.15 cm³/g, more preferably of at least 0.20 cm³/g. The macropore volume of the hydrotreating catalyst generally does not exceed 0.5 cm³/g. As the term is used herein, a macropore is a pore having a pore diameter of greater than 1000 Å. The macropore volume is measured by mercury intrusion porosimetry according to ASTM D4284.

In some examples, the hydrotreating catalyst may have a pore size distribution such that at least 15%, preferably at least 20% and even more preferably at least 25%, most preferably at least 30% of the cumulative pore volume is formed by pores having a diameter greater than 100 Å. The porosity and pore size distribution of the material can be determined by Ne adsorption at its boiling temperature and calculated from N₂ isotherms by the BJH method described by E. P. Barrett, L. G. Joyner and P. P. Halenda, “The determination of pore volume and area distributions in porous substances. I. Computations from nitrogen isotherms”, J. Am. Chem. Soc. 1951, 73, 373-380.

The hydrotreating catalyst can have a Brunauer-Emmett-Teller (BET) specific surface area of 30 m²/g or more (e.g., 50 m²/g or more, 100 m²/g or more, 200 m/g or more, 300 m²/g or more, or 400 m²/g or more) and/or 500 m²/g or less (e.g., 400 m²/g or less, 300 m²/g or less, 200 m²/g or less, 100 m²/g or less, or 50 m²/g or less). The BET specific surface area may be determined by nitrogen adsorption according to ASTM D3663.

The reduced hydrotreating catalyst is subjected to a sulfidation step (treatment) to convert the active metal components to their sulfides. In the context of the present specification, the phrases “sulfiding step” and “sulfidation step” are meant to include any process step in which a sulfur-containing compound is added to the catalyst composition and in which at least a portion of the hydrogenation metal components present in the catalyst is converted into the sulfidic form, either directly or after an activation treatment with hydrogen. Suitable sulfidation processes are known in the art. The sulfidation step can take place ex situ to the reactor in which the catalyst is to be used in hydrotreating hydrocarbon feeds, in situ, or in a combination of ex situ and in situ to the reactor. In some embodiments, the metals are substantially sulfided. A metal is regarded as substantially sulfided when the molar ratio of the sulfur present on the catalyst to the metal element is at least equal to 50% of the theoretical molar ratio corresponding to the complete sulfidation of the element under consideration. Preferably, the degree of sulfidation of the metals will be greater than 70%.

### Liquid Renewable Carrier Composition

The renewable liquid carrier composition can be any renewable liquid or mixture of liquids suitable for suspending the reduced hydrotreating catalyst.

A preferred class of renewable materials for the renewable liquid carrier composition are bio-renewable fats and oils comprising triglycerides, diglycerides, monoglycerides and free fatty acids or fatty acid esters derived from bio-renewable fats and oils. Examples of such fatty acid esters include fatty acid methyl esters, fatty acid ethyl esters. The bio-renewable fats and oils include both edible and non-edible fats and oils. Examples of these bio-renewable fats and oils include algal oil, brown grease, canola oil, carinata oil, castor oil, coconut oil, colza oil, corn oil, cottonseed oil, fish oil, hempseed oil, jatropha oil, lard, linseed oil, milk fats, mustard oil, olive oil, palm oil, peanut oil, rapeseed oil, sewage sludge, soy oils, soybean oil, sunflower oil, tall oil, tallow, used cooking oil, yellow grease, and combinations thereof.

Another preferred class of renewable materials for the renewable liquid carrier composition are liquids derived from biomass and waste liquefaction processes. Examples of such liquefaction processes include, but are not limited to, (hydro)pyrolysis, hydrothermal liquefaction, plastics liquefaction, and combinations thereof. Examples of liquids derived from biomass and waste liquefaction processes include bio-crudes, bio-oils, liquefied plastic pyrolysis oils, and tall oil products such as liquid crude tall oil (CTO), tall oil pitch (TOP), crude fatty acid (CFA), tall oil fatty acids (TOFA) and distilled tall oil (DTO). Renewable materials derived from biomass and waste liquefaction processes may be used alone or in combination with bio-renewable fats and oils. The renewable liquid carrier can also be a heavy product taken from a hydrocracking or hydrotreating process using renewable feedstocks, such as a recycled liquid for a process utilizing the renewable slurry.

The renewable materials to be used herein may contain impurities. Examples of such impurities include, but are not limited to, solids, iron, chloride, phosphorus, alkali metals, alkaline-earth metals, polyethylene and unsaponifiable compounds. If required, these impurities can be removed from the renewable feedstock before being introduced to the process of the present disclosure. Methods to remove these impurities are known to the person skilled in the art.

The renewable liquid carrier composition may additionally comprise an organic co-solvent. A co-solvent may impart improved rheological properties to renewable liquid oil carrier composition.

The organic co-solvent can be a C₂₋₆ polyol, a poly(C₂₋₃)alkylene glycol, or a mixture thereof.

Examples of C₂₋₆ polyols include C₂₋₆ diols including, but not limited to, ethylene glycol, 1,2-propanediol (α-propylene glycol), 1,3-propanediol (β-propylene glycol), 1,2-butanediol, 2,3-butanediol, 1,3-butanediol, 1,4-butanediol, 1,2-pentanediol, 1,5-pentanediol, 1,2-hexanediol and 1,6-hexanediol Examples of C₂₋₆ polyols include C₃₋₆ triols including, but not limited to, glycerol.

In this specification, the term “poly(C₂₋₃)alkylene glycol” generally means a compound having the general formula:

H—[O—CH₂—CHR]—OH

wherein R is H or methyl, and n is at least 2. When R is H, the compound is a polyethylene glycol. When R is methyl, the compound is a polypropylene glycol.

In one aspect, the poly(C₂₋₃)alkylene glycol is a polyethylene glycol having a number average molecular weight (Mₙ) of 200 to 1000. In one embodiment, the polyethylene glycol comprises or consists of a polyethylene glycol having a number average molecular weight (Mₙ) of less than 1000 or a mixture thereof. Examples of polyethylene glycols suitable for use herein include polyethylene glycol 200, polyethylene glycol 300, polyethylene glycol 400, polyethylene glycol 500, polyethylene glycol 600, polyethylene glycol 700, polyethylene glycol 800, polyethylene glycol 900, and mixtures thereof. In one embodiment the polyethylene glycol is polyethylene glycol 400 or polyethylene glycol 600, or a mixture thereof. In one particular embodiment, the polyethylene glycol is polyethylene glycol 400. In one particular embodiment, the polyethylene glycol is polyethylene glycol 600.

In one aspect, the poly(C₂₋₃)alkylene glycol is a polyethylene glycol having a number average molecular weight (Mₙ) of 200 to 1000. In one embodiment, the polypropylene glycol comprises or consists of a polypropylene glycol having a number average molecular weight (Mₙ) of less than 1000 or a mixture thereof. Examples of polypropylene glycols suitable for use herein include polypropylene glycol 200, polypropylene glycol 300, polypropylene glycol 400, polypropylene glycol 500, polypropylene glycol 600, polypropylene glycol 700, polypropylene glycol 800, polypropylene glycol 900, and mixtures thereof.

In one embodiment, the polypropylene glycol comprises or consists of a polypropylene glycol having a number average molecular weight (Mₙ) of less than 1000 or a mixture thereof. Examples of polypropylene glycols suitable for use herein include polypropylene glycol 200, polypropylene glycol 300, polypropylene glycol 400, polypropylene glycol 500, polypropylene glycol 600, polypropylene glycol 700, polypropylene glycol 800, polypropylene glycol 900, and mixtures thereof.

In at least one embodiment, the co-solvent is chosen from 1,4-butanediol, 1,5-pentanediol, polyethylene glycol 400, and polypropylene glycol 400.

In some embodiments, the co-solvent is present in an amount of about 0% to 15% by weight of the total renewable liquid carrier composition, such as from 1% to 10% by weight of the total composition, such as from 1% to 5% by weight of the total composition.

The renewable liquid carrier composition may additionally comprise a biopolymeric thickener. The biopolymeric thickener may increase the viscosity to the renewable liquid carrier composition. The biopolymeric thickener may also act to keep any solid phase catalyst suspended, thus preventing separation of the solid phase portion of the slurry catalyst composition from the liquid phase portion.

The biopolymeric thickener may comprise, consist essentially of, or consist of a non-ionic compound or non-ionic component. The biopolymeric thickener may be substantially free of ionic compounds or ionic components. The biopolymeric thickener may be substantially free of anionic compounds or anionic components. The biopolymeric thickener may be substantially free of cationic compounds or cationic components.

Non-limiting examples of non-ionic compounds include cellulose ether, xanthan gum, carrageenan, carboxymethyl cellulose, hydroxyethyl cellulose, carboxymethyl hydroxethyl cellulose, hydroxypropyl cellulose, ethyl hydroxyethyl cellulose, hydroxypropyl methylcellulose, guar gum, tragacanth gum, karaya gum, arabic gum, starch, and combinations thereof. In a preferred embodiment, the biopolymeric thickener composition is starch. The starch which may be used herein include any granular starch in raw or modified form. Preferably, the starch is in its raw, non-modified form (i.e., it is a native starch). Useful starches include those produced from corn, waxy maize, grain, sorghum, wheat, rice, potato, sago, tapioca, sweet potato, high amylose corn, or the like.

The biopolymeric thickener may be present in an amount ranging from 0.01 wt. % to 5.0 wt. %, based on the total weight of the renewable liquid carrier composition. In some embodiments, the biopolymeric thickener composition may be present in an amount ranging from 0.05 wt. % to 1 wt. %, based on the total weight of the composition.

The kinematic viscosity at 15° C. of the renewable liquid carrier composition is suitably 5 mm²/s (cSt) or more, preferably 40 mm²/s or more, more preferably 80 mm²/s or more. Likewise, the kinematic viscosity at 25° C. of renewable liquid composition is suitably 250 mm/s or less, preferably 200 mm/s or less, more preferably 150 mm²/s or less. The kinematic viscosity may be determined according to ASTM D445.

### Slurry Hydroprocessing

Slurry hydroprocesssing provides a means for conversion of low value biomass feedstocks into higher value liquid products.

Slurry hydroprocessing can be carried out in a variety of known reactors of either up- or down-flow, it is particularly well suited to a bubble column reactor through which feed, catalyst and gas move upwardly. Hence, the outlet from slurry hydroprocessing reactor is above the inlet. One or more slurry hydroprocessing reactors may be utilized in parallel or in series. Other suitable reactors include continuously stirred-tank reactors or tubular reactors.

The slurry catalyst concentrate may be added directly to the biomass feedstock in the slurry hydroprocessing reactor or may be mixed with the biomass feedstock prior to entering the reactor. The amount of catalyst can be no more than 2 wt. % (e.g., 0.5 to 2 wt. %) of the combined weight of the slurry catalyst concentrate and the biomass feedstock.

In embodiments, the operating conditions for slurry hydroprocessing may include an operating temperature from 280° C. to 550° C. For example, the operating temperature may be from 300° C. to 400° C., or 300° C. to 500° C., or 300° C. to 550° C., or 400° C. to 500° C., or 400° C. to 550° C., or 450° C. to 500° C., or 500° C. to 550° C.

In embodiments, the operating conditions for slurry hydroprocessing may include a minimum hydrogen partial pressure from 2 MPa to 25 MPa. For example, the minimum hydrogen partial pressure may be from 2 MPa to 10 MPa, or 2 MPa to 15 MPa, or 2 MPa to 20 MPa, or 5 MPa to 10 MPa, or 5 MPa to 15 MPa, or 5 MPa to 20 MPa, or 5 MPa to 25 MPa, or 10 MPa to 15 MPa, or 10 MPa to 20 MPa, or 10 MPa to 25 MPa, or 15 MPa to 20 MPa, or 15 MPa to 25 MPa, or 20 MPa to 25 MPa.

The operating conditions for slurry hydroprocessing may include a hydrogen feed rate from 500 standard liters of hydrogen to 1 liter of oil (StLt/L) to 2500 StLt/L. For example, the hydrogen feed rate may be from 500 to 1000 StLt/L, or 500 to 1500 StLt/L, or 500 to 2000 StLt/L, or 500 to 2500 StLt/L, or 1000 to 1500 StLt/L, or 1000 to 2000 StLt/L, or 1000 to 2500 StLt/L, or 1500 to 2000 StLt/L, or 1500 to 2500 StLt/L, or 2000 StLt/L to 2500 StLt/L.

Suitable liquid hourly space velocities (LHSV) for slurry hydroprocessing can range from about 0.05 h⁻¹ to 5 h⁻¹, such as 0.1 h⁻¹ to 2 h⁻¹.

Preferably, a sulfiding agent is continuously added to the slurry hydroprocessing reactor to renew the sulfide content of the catalyst. The sulfiding agent may be hydrogen sulfide or an organic sulfur-containing compound which decomposes to hydrogen sulfide in the slurry hydroprocessing reactor. Some suitable organic sulfur-containing compounds include methyl sulfides such as dimethyl sulfide (DMS) or dimethyl disulfide (DMDS), mercaptans, and polysulfides (e.g., di-tert-nonyl polysulfide).

The slurry hydroprocessing process uses a dispersed catalyst which is continuously doped into the biomass feedstock. This catalyst helps to suppress coke formation by capping free radicals formed by thermal conversion. Therefore, when a slurry hydroprocessing unit is operated once-through, the catalyst lifetime is equal to the feed residence time. This is economical because a very low concentration of catalyst is used. However, it is often desirable to increase the lifetime of the catalyst in order to reduce catalyst usage. Since it is difficult to isolate the catalyst from the product, this is most easily accomplished by bottoms recycle. Bottoms recycle increases the average catalyst lifetime. As a result, at constant make-up, the concentration of catalyst in the reactor liquid increases as bottoms recycle increases, even after accounting for reduced vaporization in the reactor. This allows the catalyst make-up rate to be reduced while maintaining equivalent coke suppression activity or, alternatively, the reactor severity can be increased while maintaining constant coke make.

The effluent from slurry hydroprocessing reactor(s) may be passed into one or more separation stages. For example, an initial separation stage can be a high pressure, high temperature (HPHT) separator. A higher boiling portion from the HPHT separator can be passed to a low pressure, high temperature (LPHT) separator while a lower boiling (gas) portion from the HPHT separator can be passed to a high temperature, low pressure (HTLP) separator. The higher boiling portion from the LPHT separator can be passed into a fractionator (e.g., an atmospheric fractionator).

The fractionator can be used to form a plurality of product streams, such as a light ends or C4-boiling range stream, one or more naphtha boiling range streams, one or more diesel and/or distillate (including kerosene) boiling range streams, and a bottoms fraction. The bottoms fraction can then be passed into vacuum fractionator to form, for example, a light vacuum gas oil, a heavy vacuum gas oil, and a bottoms or pitch fraction which typically boils above 450° C. Remaining catalyst particles from slurry hydrocracking reactor(s) may be present in the bottoms fraction and may be conveniently recycled back to the slurry hydroprocessing reactor(s). Additionally or alternatively, catalyst particles in the bottoms fraction may be sent a solid/liquid separator.

### Biomass Feedstock

The biomass feedstock is not particularly limited and may contain any combination of biomass-containing and/or biomass-derived feedstock.

As used herein, the term “biomass” generally refers to substances derived from organisms living above the earth's surface or within the earth's oceans, rivers, and/or lakes. Representative biomass can include any plant material, or mixture of plant materials, including woody biomass and agricultural and forestry products and residue, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, castor bean stalks, sugar cane bagasse, round wood, forest slash, bamboo, sawdust, sugarcane tops and trash, cotton stalks, corn cobs, Jatropha whole harvest, Jatropha trimmings, de-oiled cakes of palm, castor and Jatropha, coconut shells, residues derived from edible nut production and mixtures thereof, and sorghum, in addition to ‘on-purpose’ energy crops such as switchgrass, miscanthus, and algae. Short rotation forestry products, such as energy crops, include alder, ash, southern beech, birch, eucalyptus, poplar, willow, paper mulberry, Australian blackwood, sycamore, and varieties of paulownia elongate. Other examples of suitable biomass include organic oxygenated compounds, such as carbohydrates (e.g., sugars), alcohols, and ketones, as well as organic waste materials, such as wastepaper, construction, demolition wastes, and bio-sludge.

Organic oxygenated compounds of particular interest include those contained in triglyceride-containing components, for example naturally occurring plant (e.g., vegetable) oils and animal fats, or mixtures of such oils and fats (e.g., waste restaurant oils or grease). Triglyceride-containing components, which are representative of particular types of biomass, typically comprise both free fatty acids and triglycerides, with the possible additional presence of monoglycerides and diglycerides. Triglyceride-containing components may also include those comprising derivative classes of compounds such as fatty acid alkyl esters (FAAE), which embrace fatty acid methyl esters (FAME) and fatty acid ethyl esters (FAEE).

Examples of plant oils include algal oil, rapeseed (including canola) oil, camelina oil, castor oil, coconut oil, corn oil, colza oil, cottonseed oil, hempseed oil, jatropha oil, linseed oil, mustard oil, olive oil, palm oil, peanut oil, pennycress oil, rapeseed (including canola) oil, soybean oil, sunflower oil, and mixtures thereof. Examples of animal fats include lard, offal, tallow, train oil, milk fat, fish oil, sewage sludge, and/or recycled fats of the food industry, including various waste streams such as yellow and brown greases. Mixtures of one or more of these animal fats and one or more of these plant oils are also representative of particular types of biomass. The triglycerides and free fatty acids of a typical plant oil, animal fat, or mixture thereof, may include aliphatic hydrocarbon chains in their structures, with the majority of these chains having from about 8 to about 24 carbon atoms. Representative plant oils and/or animal fats, used as a triglyceride-containing component, may include significant proportions (e.g., at least 30%, or at least 50%) of aliphatic (e.g., paraffinic or olefinic) hydrocarbon chains with 16 and 18 carbon atoms. Triglyceride-containing components may be liquid or solid at room temperature.

A “biomass-containing” feedstock may comprise all or substantially all biomass, but may also contain non-biological materials (e.g., materials derived from petroleum, such as plastics, or materials derived from minerals extracted from the earth, such as metals and metal oxides, including glass) in significant quantities (e.g., at least 5% by weight, such as from 5% to 55% by weight, or at least 25% by weight, such as from 25% to 45% by weight). An example of a ‘biomass-containing’ feedstock that may comprise one or more non-biological materials is municipal solid waste (MSW). Such municipal solid waste may comprise any combination of lignocellulosic material (yard trimmings, pressure-treated wood such as fence posts, plywood), discarded paper and cardboard, food waste, textile waste, along with refractories such as glass, metal. Prior to use in the process of this disclosure, municipal solid waste may be optionally converted, after removal of at least a portion of any refractories, such as glass or metal, into pellet or briquette form. Co-processing of MSW with lignocellulosic waste is also envisaged. Certain food waste may be combined with sawdust or other material and, optionally, pelletized prior to use in the process of this disclosure.

“Biomass-derived”, for example when used in the phrase “biomass-derived feedstock”, refers to products resulting or obtained from the thermal and/or chemical transformation of biomass, as defined above, or biomass-containing feedstocks (e.g., MSW). Representative biomass-derived feedstocks therefore include, but are not limited to, products of pyrolysis (e.g. bio-oils), torrefaction (e.g. torrefied and optionally densified wood), hydrothermal carbonization (e.g. biomass that is pretreated and densified by acid hydrolysis in hot, compressed water), and polymerization (e.g., organic polymers derived from plant monomers). Other specific examples of biomass-derived products (e.g., for use as feedstocks) include black liquor, pure lignin, and lignin sulfonate. Biomass-derived feedstocks also extend to pretreated feedstocks that result or are obtained from thermal and/or chemical transformation, prior to, or upstream of, their use as feedstocks for a given conversion step.

The biomass feedstock encompasses feedstocks that are either liquid or solid at room temperature, or otherwise a solid-liquid slurry (e.g., crude animal fats containing solids).

In some embodiments, the biomass feedstock comprises a solid selected from the group consisting of lignocellulose, waste plastics, municipal solid waste, food waste, cellulosic feedstocks, aquaculture products, and combinations thereof.

In some embodiments, the biomass feedstock comprises at least one or more of: lignocellulosic biomass based oils, lignocellulose pyrolysis liquid (LPL) and HTL-biocrude; crude tall oil (CTO) and its derivatives; tall oil pitch (TOP), tall oil fatty acid (TOFA), distilled tall oil (DTO) and crude fatty acid (CFA); sterol containing fats, and plant and animal fats and oils.

Crude tall oil (CTO) is an untreated tall oil which comprises resin acids, fatty acids, and unsaponifiables. Resin acids are a mixture of organic acids derived from oxidation and polymerization reactions of terpenes. The main resin acid in crude tall oil is abietic acid but abietic derivatives and other acids, such as primaric acid are also found. Fatty acids are long chain monocarboxylic acids and are found in hardwoods and softwoods. The main fatty acids in crude tall oil are oleic, linoleic and palmitic acids. Unsaponifiables cannot be turned into soaps as they are neutral compounds which do not react with sodium hydroxide to form salts. They include sterols, higher alcohols and hydrocarbons. Sterols are steroids derivatives which also include a hydroxyl group.

Tall oil pitch (TOP) is a residual bottom fraction from crude tall oil (CTO) distillation processes. Tall oil pitch typically comprises from 34 to 51 wt. % free acids, from 23 to 37 wt. % esterified acids, and from 25 to 34 wt. % unsaponifiable neutral compounds of the total weight of the tall oil pitch. The free acids are typically selected from a group consisting of dehydroabietic acid, abietic and other resin acids. The esterified acids are typically selected from a group consisting of oleic and linoleic acids. The unsaponifiables neutral compounds are typically selected from a group consisting of diterpene sterols, fatty alcohols, sterols, and dehydrated sterols.

Tall oil pitch (TOP) is a residual bottom fraction from crude tall oil (CTO) distillation processes. Tall oil pitch typically comprises from 34 to 51 wt. % free acids, from 23 to 37 wt. % esterified acids, and from 25 to 34 wt. % unsaponifiable neutral compounds of the total weight of the tall oil pitch. The free acids are typically selected from a group consisting of dehydroabietic acid, abietic and other resin acids. The esterified acids are typically selected from a group consisting of oleic and linoleic acids. The unsaponifiables neutral compounds are typically selected from a group consisting of diterpene sterols, fatty alcohols, sterols, and dehydrated sterols.

Crude fatty acid (CFA) refers fatty acid-containing materials obtainable by purification (e.g., distillation under reduced pressure, extraction, and/or crystallization) of CTO.

Tall oil fatty acid (TOFA) is a fatty acid rich fraction of crude tall oil (CTO) distillation processes. TOFA typically comprises mainly fatty acids, typically at least 80 wt. % of the total weight of the TOFA. Typically, TOFA comprises less than 10 wt. % rosin acids.

Distilled tall oil (DTO) is a resin acid rich fraction of crude tall oil (CTO) distillation processes. DTO typically comprises mainly fatty acids, typically from 55 to 90 wt. %, and rosin acids, typically from 10 to 40 wt. % rosin acids, of the total weight of the DTO. Typically, DTO comprises less than 10 wt. % unsaponifiable neutral compounds of the total weight of the distilled tall oil.

Other examples of plant-based fats and oils include biocrudes and bio-oils. Biocrudes and bio-oils are produced from biomass, in particular from lignocellulosic biomass, with various liquefying methods, such as hydrothermal liquefaction, or pyrolysis, in particular fast pyrolysis.

Biocrude refers to oils produced from biomass by employing hydrothermal liquefaction (HTL), a thermal depolymerization process used to convert wet biomass into crude-like oil under moderate temperature and high pressure. Bio-oil refers to pyrolysis oils produced from biomass by employing pyrolysis (i.e., thermal decomposition of materials at elevated temperatures in a non-oxidative atmosphere). Fast pyrolysis refers to thermochemical decomposition of biomass through rapid heating in an absence of oxygen.

Examples of bio-oil and biocrude produced from lignocellulosic biomass (e.g., materials like forest harvesting residues or byproducts of a saw mill) include lignocellulosic pyrolysis liquid (LPL), produced by employing fast pyrolysis, and HTL-biocrude, produced by employing hydrothermal liquefaction.

1. A method of making a slurry catalyst concentrate comprising:
(a) reducing an average particle size of a first hydrotreating catalyst component to produce a reduced hydrotreating catalyst component having a reduced average particle size, wherein first hydrotreating catalyst component comprises one or more active metal components selected from Group VIB, Group VIII, and Group IIB metals; and
(b) mixing the reduced hydrotreating catalyst component with a renewable liquid carrier composition in a mixing vessel to provide a slurry catalyst concentrate comprising 1 to 60 wt. % of the reduced hydrotreating catalyst in the liquid renewable carrier composition.

2. The method of claim 1, wherein the reducing step comprises impact, shear, compression, vibration, grinding, crushing, or any combination thereof.

3. The method of claim 1, wherein the first average particle size is in a range from 1000 to 5000 μm and the reduced average particle size is in a range from 1 to about 500 μm.

4. The method of claim 1, wherein the one or more active metal components are selected from Mo, W, Fe, Co, Ni, and Zn.

5. The method according to claim 1, wherein the catalyst is present in supported or unsupported form, wherein if the catalyst is present in supported form, then the support material is optionally selected from the group consisting of carbon, activated carbon, silicon oxide, aluminum oxide, manganese oxide, cerium oxide, zirconium oxide, lanthanum oxide, titanium oxide and mixtures of two or more of these materials.

6. The method according to claim 1, wherein the first hydrotreating catalyst component is a fresh hydrotreating catalyst, a spent hydrotreating catalyst, or a combination thereof.

7. The method of claim 1, wherein the first hydrotreating catalyst component contains up to 20 wt. % of floor sweep or catalyst fines from a catalyst manufacturing plant.

8. The method of claim 1, wherein the first hydrotreating catalyst component has a macropore volume of from 0.10 cm³/g to 0.5 cm³/g, or a pore size distribution such that at least 15% of the cumulative pore volume is formed by pores having a diameter greater than 100 Å, or a BET surface area of at least 50 m²/g.

9. The method according to claim 1, wherein the renewable liquid carrier composition is selected from the group consisting of one or more bio-renewable fats and oils, liquid derived from a biomass liquefaction process, liquid derived from a waste liquefaction process, and combinations thereof.

10. The method of claim 1, wherein the renewable liquid carrier comprises a heavy product taken from a hydrocracking or hydrotreating process using renewable feedstocks.

11. The method of claim 1, wherein the renewable liquid carrier has a kinematic viscosity at 15° C. of at least 5 mm²/s.

12. The method of claim 1, wherein mixing is performed for 10 minutes to 3 hours.

13. The method of claim 1, wherein the renewable liquid carrier composition further comprises a biopolymeric thickener.

14. The method of claim 13, wherein the biopolymeric thickener comprises starch.

15. A process for slurry hydroprocessing, comprising:
(a) reducing an average particle size of a first hydrotreating catalyst component to produce a reduced hydrotreating catalyst component having a reduced average particle size, wherein the first hydrotreating catalyst comprises one or more active metal components selected from Group VIB, Group VIII and Group IIB metals;
(b) mixing the reduced hydrotreating catalyst component with a renewable liquid carrier composition in a mixing vessel to provide a slurry catalyst concentrate comprising 1 to 60 wt. % of the reduced hydrotreating catalyst in the liquid renewable carrier composition; and
(c) charging the slurry catalyst concentrate and a biomass feedstock to a slurry hydroprocessing reactor.

16. The process of claim 15, wherein an amount of catalyst is no more than 2 wt. % of a combined weight of the slurry catalyst concentrate and the biomass feedstock.

17. The process of claim 15, wherein a sulfiding agent is continuously introduced to the slurry hydroprocessing reactor.

18. The process of claim 15, wherein the biomass feedstock contains at least one or more of lignocellulosic biomass based oils, lignocellulose pyrolysis liquid (LPL) and HTL-biocrude;
crude tall oil (CTO) and its derivatives; tall oil pitch (TOP), tall oil fatty acid (TOFA), distilled tall oil (DTO) and crude fatty acid (CFA); sterol containing fats, and plant and animal fats and oils.
